(19) United States
(12) Patent Application Publication
(10) Pub. No.: US 2005/0053840 A1
(43) Pub. Date: Mar. 10, 2005

(54) Lithium secondary battery comprising fine fibrous porous polymer membrane and fabrication method thereof

(75) Inventors: Seong Mu Jo, Seoul (KR); Wha Seop Lee, Seoul (KR)

Correspondence Address: MORRISON & FOERSTER LLP, 1650 TYSONS BOULEVARD, SUITE 300, MCLEAN, VA, 22102, US

(73) Assignee: Korea Institute of Science and Technology, Seoul (KR)

(21) Appl. No.: 10/887,226

(22) Filed: Jul. 9, 2004

(30) Foreign Application Priority Data
Jul. 9, 2003 (KR) 46403/2003

(51) Int. Cl. H01M 2/16; H01M 10/40

(52) U.S. Cl. 429/247; 429/254; 429/255; 429/314; 429/317; 429/316

(57) ABSTRACT

Disclosed are a lithium secondary battery comprising a fibrous membrane/electrode composite in which an ultra-fine fibrous porous polymer membrane is combined with an electrode into one body and a hybrid type polymer electrolyte in which pores of the ultra-fine fibrous porous polymer membrane is impregnated with an organic electrolyte solution or a polymer electrolyte; and a fabrication method thereof.

### BACKGROUND OF THE INVENTION

1. Field of the Invention

The present invention relates to a lithium secondary battery comprising a ultra-fine fibrous porous polymer membrane and a fabrication method thereof.

2. Description of the Related Art

Since electronic apparatus have become miniaturized and light-weighted, researches for developing energy sources having high density and energy have been intensively performed. A lithium secondary battery has been proposed as one energy source in view that the higher integration of energy is possible because molecular weight of lithium is very low while its density is relatively high.

The early lithium secondary batteries were fabricated with metallic lithium or a lithium alloy as an anode. However, the cycle characteristic of the secondary battery using metallic lithium or a lithium alloy is low due to the dendrite formed on the anode as a result of repeated charging and discharging of the battery.

A lithium ion battery has been proposed in order to solve the problem of dendrite formation. The lithium ion battery comprises an anode active material, a cathode active material, an organic electrolyte solution and a separator. The separator functions to prevent internal short-circuiting caused by contacting of a cathode and an anode of a lithium ion battery, and to permeate ions. Separator generally used at the present time are polyethylene (hereinafter referred to as “PE”) or polypropylene (hereinafter referred to as “PP”) separator. In fabrication of a lithium ion battery, it is difficult to stack electrodes and separator in plate shape, and therefore, the electrodes and separator are rolled and then inserted into a cylindrical casing (See D. Linden, Handbook of Batteries, McGRAW-HILL INC., New York (1995)). Since a lithium ion battery was developed by SONY Company in Japan, it has been widely used around the world; however, those using PE or PP separator have problems such as instability of the battery, intricacy of its fabrication process, restriction on battery shape and limitation of high capacity. There have been attempts to solve those problems, but no clear output has been reported until now.

On the contrary, a lithium polymer battery uses a polymer electrolyte having two functions as a separator and an electrolyte, and it has been now viewed with keen interest as a battery which is able to solve all of the above-described problems of the lithium ion battery. The lithium polymer battery has advantages in view of productivity because the electrodes and polymer electrolyte can be stacked in plate shape, and its fabrication process is similar to that of a polymer film.

A conventional polymer electrolyte is mainly prepared with polyethylene oxide (hereinafter referred to as “PEO”) as polymer matrix, but its ionic conductivity is merely 10⁻⁸ S/cm at room temperature, and accordingly it can not be commercialized.

Recently, a gel or hybrid type polymer electrolyte having an ionic conductivity above 10⁻³ S/cm at room temperature has been developed.

A gel type polyacrylonitrile (hereinafter referred to as “PAN”) based polymer electrolyte is disclosed in U.S. Pat. No. 5,219,679 to K. M. Abraham et. al and U.S. Pat. No. 5,240,790 to D. L. Chua et. al. The gel type PAN based polymer electrolyte is prepared by injecting an organic electrolyte prepared with a lithium salt and organic solvents, such as ethylene carbonate and propylene carbonate, etc. into a polymer matrix. It has an advantage in that contact resistance is small in charging/discharging of a battery and desorption of the active materials rarely takes place, because its adhesive force is good, and accordingly it can be well attached with a composite electrode or a metal substrate. However, such polymer electrolyte has a problem in that its mechanical stability, namely, its strength, is low because the electrolyte is a little bit soft. Especially, such low mechanical strength may cause many problems in fabrication of electrodes and batteries.

Recently a polymer electrolyte of a polymethylmethacrylate (hereinafter referred to as “PMMA”) group has been reported in Solid State lonics, 66, 97, 105 (1993) by O. Bohnke, G. Frand et al. The PMMA polymer electrolyte has advantages in that its Ionic conductivity is 10⁻³ S/cm at room temperature, and its adhesive force and compatibility with the organic electrolyte solution are good. However, it is not suitable for a lithium polymer battery because its mechanical strength is very poor.

In addition, a polyvinylchloride (hereinafter referred to as “PVC”) based polymer electrolyte having good mechanical strength and ionic conductivity of 10⁻³ S/cm at room temperature has been reported in J. Electrochem. Soc., 140, L96 (1993) by M. Alamgir and K. M. Abraham. However, its low-temperature characteristics are poor and its contact resistance is high.

A hybrid type of poly(vinylidene fluoride) (hereinafter referred to as “PVdF”) based polymer electrolyte is disclosed in U.S. Pat. No. 5,460,904 to A. S. Gozdz et al. Hybrid type PVdF based polymer electrolyte is prepared by preparing a polymer membrane having nanopores, followed by injecting an organic electrolyte into the pores. It has advantages in that its compatibility with organic electrolytes is good, the electrolyte injected into the small pores is not leaked so as to be safe in use, and the polymer membrane can be fabricated in an atmospheric environment because the organic electrolyte is injected later. However, it has a disadvantage in that its fabrication process is intricate because in preparation of the polymer electrolyte, it is necessary to extract plasticizer contained in a polymer matrix in order to obtain a nanoporous matrix. In addition, if the plasticizer is not been completely extracted, remained plasticizer can cause weaken characteristics of the battery. Further, it has a serious disadvantage that an additional lamination process is required in fabrication of electrodes and batteries, because its adhesive force is poor, while its mechanical strength is good.

In the meantime, electrostatic spray (or electrospray) phenomenon, in which a liquid is sprayed as ultra-fine drops in a high voltage electric field not less than threshold voltage, has been known long time ago. Since it was possible to obtain submicron-sized aerosol having narrow size distribution by using such phenomenon, it has been an object of interest scientifically and industrially. In more detail, lots of researches have been performed on an electrospary process, and such process has been efficiently applied in industrial fields, for example, liquid aerosol, inkjet printing, painting and fabrication of metallic particles, etc.

When high voltage electrostatic force is applied to a polymer solution or a polymer melt having greater viscosity compared to a common liquid, the electrospray phenomenon also occurs. However, in this case, it is not sprayed as utra-fine drops like a liquid of low viscosity, but formed ultra-fine fiber. Although such phenomenon has been known from J. Phys. Rev. 10, 1 (1917) by Zeleny et al., the electrospray phenomenon of polymer has not been noticed greatly for a long time.

With the advent of the nanotechnology which has been becoming a big issue in the fields of science and technology these days, the electrospray phenomenon of polymer has become the object of interest because of possibility to make an ultra-fine fiber having a diameter of several nm to several μm. Accordingly, in order to differentiate an electrospray phenomenon of polymer fluid with high viscosity, in which utra-fine fibers are formed, from an electrospray phenomenon of fluid with low viscosity fluid, it is referred to as “electrostatic spinning” or “electrospinning”, and recently the term “electrospinning” has been mainly used in the academic world. In the present invention, forming a fiber using an electrospray phenomenon of high viscosity fluid such polymer, its hybrid, etc., is referred to as “electrospinning”.

In the case of using the electrospinning, it is possible to obtain an ultra-fine fiber having a diameter of several nm to several μm. It is also possible to prepare a porous fibrous membrane like web because it forms a three-dimensional network structure with fusion between the deposited fibers during the electrospinning. Therefore, ultra-fine fibrous membrane can be an ultra-thin, ultra-light weighted and have a high ratio of surface area to volume in comparison with the conventional fiber and have a high porosity. Therefore, structurally it has respiratory characteristic capable of emitting sweat, etc. and wind-proof characteristic, and it can be prepared to prevent external liquid from impregnating therethrough. Accordingly, researches using the electrospinning phenomenon of polymer have been conducted in various fields, for example, for preparing a high performance filter, porous scaffold for tissue engineering, fabrication of a chemical sensor, etc.

Besides, in the porous polymer membrane comprised an ultra-fine polymer fiber prepared by electrospinning, the diameter of the fiber is small, and thus, the ratio of surface area to volume and the void ratio are very high compared with those of a separator made of PE or PP, which has been used for a conventional lithium ion battery. Therefore, if the porous fibrous polymer membrane is used as a separator for lithium secondary battery, due to the high porosity of the porous fibrous polymer membrane, the amount of impregnated electrolyte is large to result in increased ionic conductivity. In addition, due to the large surface area and porosity, its contact area with electrolyte can be increased so that the leakage of the electrolyte can be minimized. Accordingly, PCT international publication Nos. WO 01/89020, WO 01/89021, WO 01/89022 and WO 01/89023, etc disclose a lithium secondary battery comprising an ultra-fine fibrous porous polymer membrane and a fabrication method thereof.

A fabrication method of a lithium secondary battery disclosed in the above applications comprising (1) laminating an ultra-fine fibrous porous polymer membrane on electrodes in a battery assembly process, followed by injecting an organic electrolyte solution thereinto; or (2) directly coating by epectrospinning of a polymer solution onto electrodes to form a ultara-fine fibrous porous polymer membrane thereon, laminating the obtained electrodes in a battery assembly process, and followed by injecting an organic electrolyte solution or a polymer electrolyte into pores of the membrane.

However, in the method (1), if an ultra-fine fibrous porous polymer membrane is weaker than a PE or PP film in mechanical strength, there might be a problem in fabrication of a lithium secondary battery. In the meantime, in the method (2), electrodes may be damaged by a solvent contained in the polymer solution. Besides, in a lithium secondary battery fabricated by the method (1) or (2), adhesive force between a fibrous membrane is weak to some extent, it is necessary to improve this problem.

### SUMMARY OF THE INVENTION

It is an object of the present invention to provide a lithium secondary battery having advantages of both a lithium ion battery and a lithium polymer battery.

It is another object of the present invention to provide a lithium secondary battery having improved energy density, cycle characteristics, low- and high-temperature characteristics, high-rate discharge characteristics and stability in comparison with those of the conventional lithium secondary battery.

It is still another object of the present invention to provide a fabrication method of a lithium secondary battery by a simple process, which is suitable to scale-up of a battery.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view illustrating a construction of a polymer electrospinning apparatus;

FIGS. 2a and 2b are Scanning Electron Microscope (SEM) images for ultra-fine fibrous porous polymer membranes prepared by electrospinning;

FIG. 3 is a diagram illustrating a process for fabricating a fibrous membrane/electrode composite by combining an ultra-fine fibrous porous polymer membrane with an electrode;

FIGS. 4a and 4b are diagrams illustrating a process for fabricating a lithium secondary battery according to the present invention with a fibrous membrane/electrode composite;

FIG. 5 is a graph illustrating charge/discharge characteristics of the lithium secondary batteries of Examples 3-1 to 3-7 and Comparative Examples 1 to 3;

FIGS. 6a and 6b are graphs illustrating low- and high-temperature characteristics of the lithium secondary batteries of Example 3-1 and Comparative Examples 2 and 3; and

FIGS. 7a to 7c are graphs illustrating high-rate discharge characteristics of the lithium secondary batteries of Example 3-1 and Comparative Examples 2 and 3.

### DETAILED DESCRIPTION OF THE PREFERRED EMBODIMENT

The present invention is to improve performance of lithium secondary batteries disclosed in International publication Nos. WO 01/89020, WO 01/89021, WO 01/89022 and WO 01/89023, etc. Objects of the present invention is achieved by providing a fibrous membrane/electrode composite in which an ultra-fine fibrous polymer membrane is combined with an electrode, a lithium secondary battery comprising an organic electrolyte solution or a polymer electrolyte incorporated into the pores of the separator of the above fibrous membrane/electrode composite, and fabrication method thereof.

Accordingly, the present invention relates to a lithium secondary battery comprising a fibrous membrane/electrode composite in which a electrospun ultra-fine fibrous porous polymer membrane having good adhesiveness with an electrode and good compatibility with an organic electrolyte is combined with a cathode and/or an anode into one body; and a “hybrid type polymer electrolyte”. The term “hybrid type polymer electrolyte” means an electrolyte in which an organic electrolyte solution or a polymer electrolyte incorporated into the pores of the electrospun ultra-fine fibrous polymer membrane.

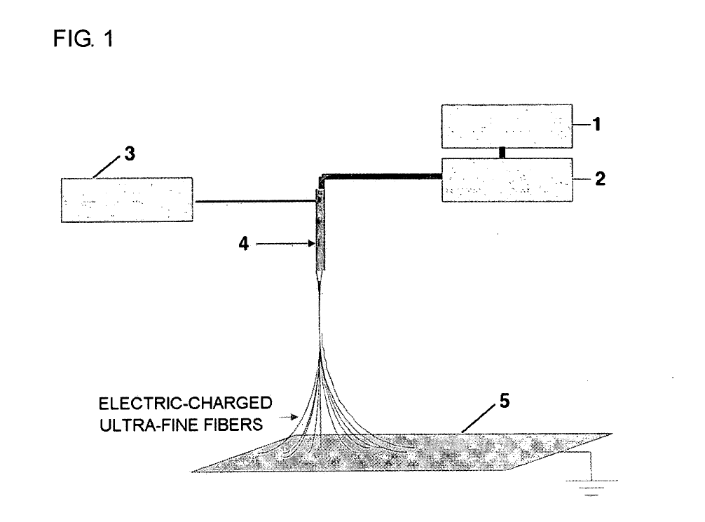

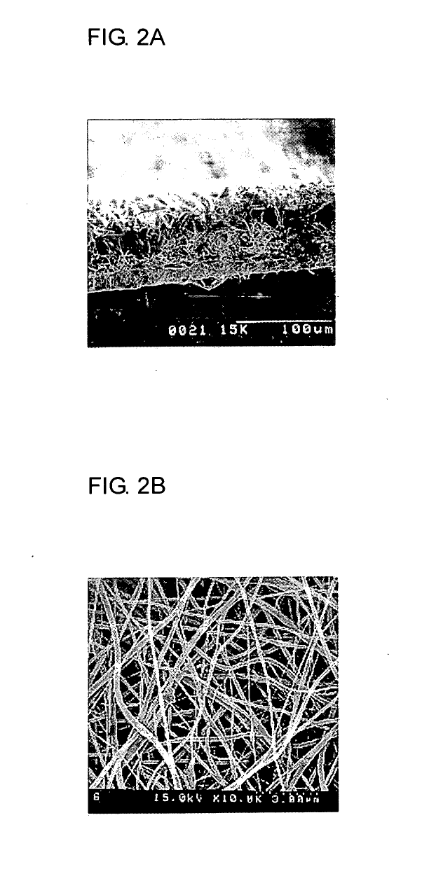

FIGS. 2a and 2b are SEM images for an ultra-fine fibrous polymer membrane prepared by electrospinning with an apparatus shown in FIG. 1. As can be seen from FIGS. 2a and 2b, in the ultra-fine fibrous porous polymer membrane, ultra-fine polymer fibers having a small diameter are disorderly and three-dimensionally stacked, and due to small diameter of the fibers, the ratio of surface area to volume and porosity are very high compared with conventional separators. Therefore, the electrolyte uptake is large, an ionic conductivity is also high, and surface area is large in spite of the high void ratio, to result in increasing its contact area with organic electrolyte solution and good affinity (compatibility) with the organic electrolyte solution.

In the present invention, there is no specific limitation on the thickness of the ultra-fine fibrous porous polymer membrane, but it is preferable that the ultra-fine fibrous porous polymer membrane has a thickness of 1 μm-100 μm in order to control the size of a pore and porosity, and physical properties such as mechanical strength in the combining process with an electrode. The fiber diameter in the ultra-fine fibrous porous membrane is preferably in the range of 1-3000 nm, and more preferably 50 nm-1000 nm. Before the ultra-fine fibrous porous polymer membrane is combined with an electrode, porosity is in the ranges of 30-90%, pore size is preferably in the range of 10 nm-10 μm and more preferably of 50 nm-1 μm, and the impregnation ratio of an electrolyte is about 50%-500% by weight of the membrane.

No limitation on a polymer for the ultra-fine fibrous porous polymer membrane is necessary as long as it can be formed into an ultra-fine fiber, in particular, by the electrospinning. Examples of such polymer include polyethylene, polypropylene, cellulose, cellulose acetate, cellulose acetate butylate, cellulose acetate propionate, poly(vinylpyrrolidone-vinylacetate), poly{bis[2-(2-methoxyethoxy)phosphagene]}, poly(ethyleneimide), polyethyleneglycol derivatives including polyethyleneglycol dialkylether and polyethyleneglycol dialkylester, polyethyleneoxide, polyethylenesuccinate, polyethylenesulfide, poly(oxymethylene-oligo-oxyethylene), polypropyleneoxide, polyvinylacetate, polyurethane copolymer including polyurethane and polyetherurethane, polystyrene, polystyrene acrylonitrile copolymer, polyester, nylon, polyacrylonitrile, polyacrylonitrile copolymer including. polyacrylonitrile methylmethacrylate copolymer, polymethylmethacrylate, polymethylmethacrylate copolymer, polyvinylchloride, poly(vinylidene fluoride), poly(vinylidenefluoride-co-hexafluoropropylene), perfluoropolymers and mixtures thereof. However, the polymer is not limited to the above examples, and any polymer can be used as long as it is electrochemically stable and compatible with an organic electrolyte solution.

In the present invention, the “organic electrolyte solution” means an electrolyte in which a lithium salt is dissolved in an organic solvent, and the “polymer electrolyte” means an electrolyte in which a polymer is dissolved in the organic electrolyte solution or in which a lithium salt is dissolved in a polymer to form a complex of a polymer/lithium salt complex.

In the present invention, lithium salts are the same as generally used in the filed of the lithium secondary battery, and examples include LiPF₆, LiClO₄, LiAsF₆, LiBF₄, LiCF₃SO₃ and the like, and LiPF₆ is more preferable.

Examples of an organic solvent for the organic electrolyte solution include ethylene carbonate, propylene carbonate, diethyl carbonate, dimethyl carbonate, ethylmethyl carbonate and mixtures thereof.

In the organic electrolyte solution, the concentration of a lithium salt in an organic solvent is in the range of 0.5M-3M, and 1M organic electrolyte solution is mainly used.

The polymer electrolyte, in which a polymer is dissolved in an organic electrolyte solution, can be prepared by completely dissolving a polymer in an organic electrolyte solution, in which lithium salt is dissolved, at 20° C.-150° C. In the polymer electrolyte, the ratio of polymer to an organic electrolyte solution can be varied depend on the kind of polymer, and its molecular weight and solubility in an organic electrolyte solution, and it is preferable to be 1:1-50. The polymer electrolyte in which polymer is dissolved in the organic electrolyte solution has high viscosity compared with an organic electrolyte solution, and has fluidity or gel property having weak fluidity even at room temperature.

The polymer/lithium salt complex is an electrolyte in solid state. However, in the present invention, it is a complex formed from a polymer having fluidity even at room temperature, for example, polyethyleneglycol dimethylether, and a lithium salt. If it is necessary to improve characteristics of the polymer/lithium salt complex, for example, ionic conductivity and the like, a plasticizer and/or an inorganic additive can be added.

It is advantageous that due to the high viscosity of the polymer electrolyte, when it is incorporated into the pores of the fibrous membrane, leakage of the electrolyte can be greatly reduced compared with an organic electrolyte solution, while it exhibits ionic conductivity not less than 10⁻³ S/cm similar to that of the organic electrolyte solution.

Examples of polymers for the polymer electrolyte include cellulose, cellulose acetate, cellulose acetate butylate, cellulose acetate propionate, polyvinylpyrrolidone-vinylacetate, poly{bis[2-(2-methoxy ethoxy)phosphagene]}, polyethyleneimide, polyethyleneglycol dialkylether, polyethyleneglycol dialkylester, triethyleneglycol dialkylether, oligomer of polyethylene glycol diacrylate and derivatives thereof, polyethyleneoxide, polyethylenesuccinate, polyethylenesulfide, poly(oxymethylene-oligo-oxyethylene), polypropyleneoxide, polyether, polyvinylacetate, polyurethane, polyurethane copolymer including polyetherurethance, polystyrene, poly(styrene-acrylonitrile), polyacrylonitrile, polyacrylonitrile copolymer including poly(acrylonitrile-methylmethacrylate), polymethylmethacrylate copolymer including polymethylmethacrylate, polyvinylchloride, poly(vinylidene fluoride), poly(vinylidenefluoride-co-hexafluoropropylene), perfluoropolymers and mixtures thereof. However, the polymer for the polymer electrolyte is not limited to the above examples and any polymer can be used as long as it is electrochemically stable and compatible with an organic electrolyte solution, and exhibits high ionic conductivity.

It can be possible to raise temperature in order to increase solubility of polymer in the organic electrolyte solution. However, it may result in the composition change of the organic electrolyte solution due to evaporation of the organic solvent, or polymer may be decomposed. Therefore, if the solubility of the polymer in the organic electrolyte solution is low, it is preferable that a plasticizer is added in order to improve solubility, so as to obtain uniform polymer electrolyte without raising the temperature.

When a plasticizer is added to the polymer electrolyte, the polymer and a plasticizer are mixed in the ratio of 1:1-20 by weight.

Examples of the plasticizer include propylene carbonate, dimethyl carbonate, 1,2-dimethoxyethane, 1,3-dimethyl-2-imidazolidinone, dimethylsulfoxide, ethylene carbonate, ethylmethyl carbonate, N,N-dimethylformamide, N,N-dimethylacetamide, N-methyl-2-pyrrolidone, polyethylenesulfolane, tetraethylene glycol dimethyl ether, acetone, alcohol or mixtures thereof. However, because a plasticizer is removed during the battery fabrication, it is not limited to the above plasticizers.

An inorganic additive can improve mechanical strength of the polymer electrolyte, electrochemical properties such as ionic conductivity and interaction with the fibrous membrane. Preferable examples of such inorganic additives include TiO₂, BaTiO₃, Li₂O, LiF, LiOH, Li₃N, BaO, Na₂O, Li₂CO₃, LiAlO₂, SiO₂, Al₂O₃, PTFE and mixtures thereof. It is preferable that the content of the inorganic additive is below 20% by weight of the polymer of the polymer electrolyte.

The lithium secondary battery according to the present invention comprises a “hybrid type polymer electrolyte”, in which an organic electrolyte solution or a polymer electrolyte is incorporated into the pores of the ultra-fine fibrous polymer membrane and formed therein.

In the porous polymer membrane having a diameter of 1-3000 nm, due to the small diameter of the fibers, the ratio of surface area to volume and porosity are higher compared with the conventional separator. Therefore, the electrolyte uptake is large, the ionic conductivity is high, its contact area with the organic electrolyte solution is large due to its large surface area in spite of its high porosity, and its compatibility with an organic electrolyte solution is good. Therefore, in the “hybrid type polymer electrolyte”, ionic conductivity is high, and leakage of the organic electrolyte solution is inhibited.

In the lithium secondary battery according to the present invention, anode and cathode can be prepared by mixing a certain amount of an active material, a conductive material, a binder and an organic solvent, casting the mixture on both sides of copper or aluminum plate grid, and followed by drying and rolling the same, similar to the conventional lithium secondary battery. The anode active material is selected from the group consisting of graphite, cokes, hard carbon, tin oxide and lithiated compounds thereof, lithium, lithium alloys and mixtures thereof. The cathode active material is selected from the group consisting of LiClO₂, LiNiO₂, LiNiCoO₂, LiMn₂O₄, V₂O₅, V₆O₁₃ and mixtures thereof.

The present invention also relates to a fabrication method of a lithium secondary battery as described above.

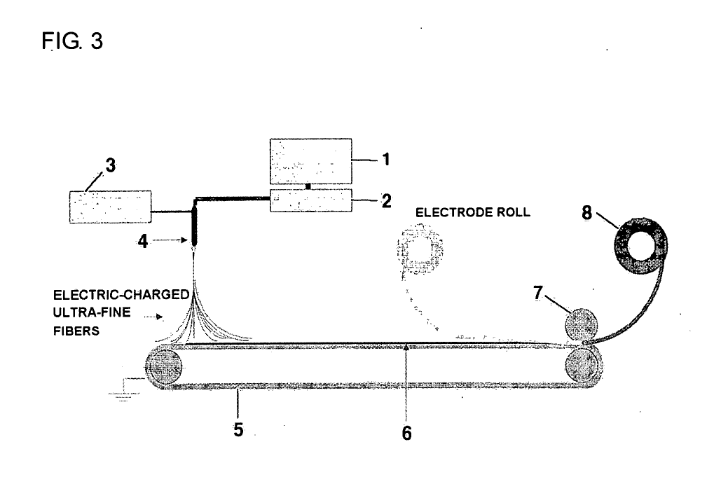

In order to secure adhesive strength between an electrode and an ultra-fine fibrous porous membrane and process stability, as depicted in FIG. 3, the fabrication method of the lithium secondary battery according to the present invention comprises electrospinning a polymer melt or a polymer solution onto a earthed metal conveyer collector plate of an electrospinning apparatus to form an ultra-fine fibrous porous membrane; adhering the ultra-fine fibrous porous membrane with one or both sides of anode or cathode and heating-laminating the resultant, so as to make one body; separating the resultant from the collector plate of the electrospinning apparatus to obtain a fibrous membrane/cathode composite or a fibrous membrane/anode composite; and constructing a lithium secondary battery using the obtained the fibrous membrane/electrode composite.

In more detail, the fabrication method of the lithium secondary battery according to the present invention comprises:
(a) electrospinning a polymer melt or a polymer solution onto a grounded metal conveyer collector plate of an electrospinning apparatus to form an ultra-fine fibrous porous fibrous membrane;
(b) adhering one or both sides of an anode or a cathode to the ultra-fine fibrous porous membrane and heat-laminating the resultant, and followed by separating the same from the collector plate of the electrospinning apparatus, to obtain a fibrous membrane/electrode composite; and
(c) constructing a lithium secondary battery with the fibrous membrane electrode composite obtained from step (b).

Reference numerals shown in FIGS. 1 and 3 indicate as follows:
1: barrel of the electrospinning apparatus;
2: constant quantity pump;
3: high voltage generator;
4: spinning nozzle;
5: earthed metal conveyer collector plate;
6: an ultra-fine fibrous porous polymer membrane;
7: heat-laminating roller; and
8: fibrous membrane/electrode combined roll.

In step (a), a polymer melt or a polymer solution in which polymer is dissolved in an organic solvent is injected into the barrel 1 of the electrospinning apparatus and a high voltage is applied to the spinning nozzle 4 by the high voltage generator 3 while a feed rate of polymer is controlled with the constant quantity pump 2, so as to obtain the ultra-fine fibrous porous polymer membrane 6, which is the three-dimensionally stacked ultra-fine fibers having a diameter of 1-3000 nm, onto the earthed metal conveyer collector plate 5.

Thickness and mechanical characteristics of the fibrous membrane 6, diameter and morphology of the fiber, etc. can be adjusted by controlling electrospinning process conditions such as applied voltage, the kind and viscosity of the polymer solution and a feed rate of polymer, etc. In a preferable condition, voltage is in the range of 500 V-100 kV, viscosity of the polymer solution is in the range of about 1-5,000 poise, and a feed rate of the polymer solution is in the range of 1 μl/min-10 ml/min.

In step (a), it is possible to prepare an ultra-fine fibrous porous polymer membrane with two or more polymers. That is, (i) two or more polymers are melted together or dissolved in at least one organic solvent, and injecting the resultant into a barrel of the electrospinning apparatus and followed by discharging the same through a nozzle, to obtain an ultra-fine fibrous porous polymer membrane in which fibers of mixtures of the two or more polymer are entangled together; or (ii) two or more polymers are separately melted or dissolved in organic solvents in separated containers, and injecting the resultants respectively into different barrels of the electrospinning apparatus and followed by discharging them through different nozzles, to obtain an ultra-fine fibrous porous polymer membrane in which two or more polymer fibers are entangled together.

In step (a), if an ultra-fine fibrous porous polymer membrane is obtained from a polymer solution, organic solvent is not particularly limited to any specific kinds as long as it can sufficiently dissolve a polymer and can be applicable to the electrospinning. An organic solvent that might influence on the characteristics of the battery can even be used, because the organic solvent is almost completely removed while fabricating a porous polymer membrane by the electrospinning. Examples of the organic solvent include propylene carbonate, dimethyl carbonate, 1,2-dimethoxyethane, 1,3-dimethyl-2-imidazolidinone, dimethylsulfoxide, ethylene carbonate, ethylmethyl carbonate, N,N-dimethylformamide, N,N-dimethylacetamide, N-methyl-2-pyrrolidone, polyethylenesulfolane, tetraethylene glycol dimethyl ether, acetone, alcohol and mixtures thereof.

In step (b), the ultra-fine fibrous porous polymer membrane obtained in step (a) is combined with one or both sides of an anode or a cathode, and the resultant is heat-laminated with the heat-laminating roller 7 and then separated from the collector plate 6 of the electrospinning apparatus, to obtain a fibrous membrane/electrode composite 8 in which the ultra-fine fibrous porous polymer membrane is combined with the electrode into one body. Herein, in the case of combining the fibrous membrane with a cathode, it gives a fibrous membrane/cathode composite, and in the case of combining the fibrous membrane with an anode, it gives a fibrous membrane/anode composite.

In step (c), (i) the fibrous membrane/cathode composite and the fibrous membrane/anode composite obtained in step (b) as described above are combined with each other, the resultants is then heat-laminated to obtain an electrode body in which cathode/fibrous membrane/anode are combined into one body, and then an organic electrolyte solution or a polymer electrolyte is injected into the electrode body; or (ii) an organic electrolyte solution or a polymer electrolyte is respectively injected into the fibrous membrane/cathode composite and the fibrous membrane/cathode composite obtained in step (b) as described above, the resulting the fibrous membrane/cathode composite and the fibrous membrane/cathode composite is combined with each other, the resultant is laminated and then stacked or rolled, and then inserted into a battery casing, and if necessary, an organic electrolyte solution or a polymer electrolyte is additionally injected thereinto, and the resultant is finally sealed.

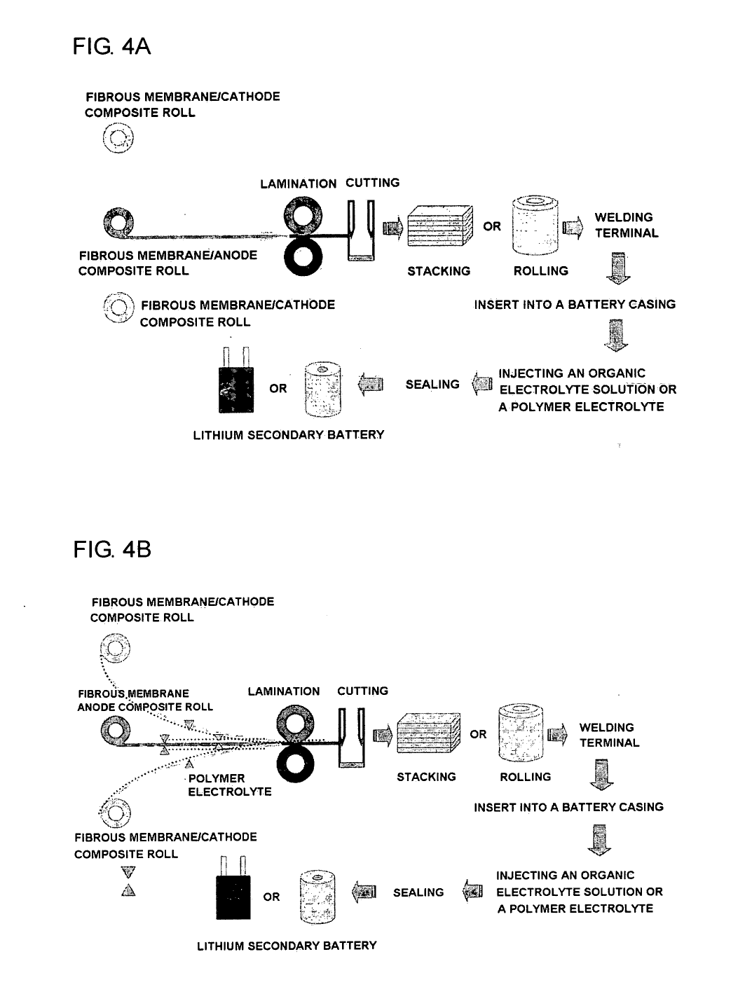

FIGS. 4a and 4b are diagrams illustrating the process according to the present invention for fabricating a lithium secondary battery with a fibrous membrane/electrode composite. FIG. 4a shows the process for fabricating a battery comprising the steps of heat-laminating the cathode and anode respectively combined with a fibrous membrane together to obtain an electrode body in which a cathode/fibrous membrane/anode is combined into one body, stacking or rolling the resultant and then inserting the same into a battery casing, and injecting an organic electrolyte solution or a polymer electrolyte thereinto and sealing the resultant. FIG. 4b shows the process for fabricating a battery comprising the following steps of injecting an organic electrolyte solution or a polymer electrolyte into an electrode composite in which an ultra-fine fibrous porous polymer membrane is combined to the electrode, laminating the anode and the cathode, stacking or rolling the resultant, and inserting the same into a battery casing, additionally injecting an organic electrolyte solution or a polymer electrolyte thereinto and sealing the resultant.

The lithium secondary battery according to the present invention fabricated by the above-described method comprises a fibrous membrane/electrode composite in which an ultra-fine fibrous porous polymer membrane and electrode are made into one body by combining the fibrous membrane on the active surface of the electrode; and a “hybrid type polymer electrolyte” in which the pores of the separator were impregnated with an organic electrolyte solution or a polymer electrolyte.

### EXAMPLES

The present invention will be better understood from the following Examples, but those examples are given only to illustrate the present invention, not to limit the scope of the invention thereto.

In the following Examples and Comparative Examples, the cathode is the one that a slurry of PVdF binder, super-P carbon and LiCoO₂ (manufactured by Japan Chemical Company) was cast onto aluminum foil, and an anode is the one that a slurry of MCMB (manufactured by Osaka Gas Company), PVdF, super-P carbon was cast onto copper foil. However, the cathode and anode of the present invention are not limited to the above examples, any cathode and anode known to a person of ordinary skill in the art can be used for fabricating the lithium secondary battery according the present invention within its spirit and scope as defined in the appended claims. In preparing the cathode and the anode, after casting the slurry, in order to improve adhesive force between particles in the electrode and between the electrode and metal foil, roll-pressing was performed to make the electrode have about 50 μm in thickness.

### Example 1

### Preparation of a Separator/Electrode Composite in Which an Ultra-Fine Fibrous Porous Polymer Membrane is Combined onto the Electrode

### Example 1-1

20 g of PVdF (Kynar 761) was added to 100 g of dimethylacetamide/acetone mixture, and the resulting mixture was stirred at room temperature to give a clear polymeric solution. The resulting polymeric solution was introduced into a barrel of an electrospinning apparatus and then discharged onto a metal collector plate 5 at 100 μl/min with a constant quantity pump 2. At the same time, by applying 9 kV of electric charge to a spinning nozzle 4, an ultra-fine fibrous porous polymer membrane 6 of 50 μm in thickness was formed onto the earthed metal conveyer collector plate 5 that was moving at 1 m/min.

Next, as shown in FIG. 3, on the end portion of the conveyer, the collector plate, on which the fibrous polymer membrane was stacked, was adhered onto the surface of a cathode or an anode, heat-laminating process was performed with a roller 7 which was pre-heated at about 100° C., the electrode was then separated from the collector plate, to obtain a fibrous membrane/electrode composite 8, in which the ultra-fine fibrous porous polymer membrane was combined with the electrode.

In a manner as described above, a fibrous membrane/cathode composite in which an ultra-fine fibrous porous polymer membrane was combined with one or both sides of LiCoO₂ cathode was prepared, and a fibrous membrane/anode composite, in which an ultra-fine fibrous porous polymer membrane was combined with one or both sides of graphite anode was prepared.

### Example 1-2

10 g of PVdF (Kynar 761) and 10 g of PAN (obtained from Polyscience Company, molecular weight of 150,000) were added into 100 g of dimethylacetamide, and the resulting mixture was stirred at room temperature for 24 hours to give a clear polymeric solution. Using the polymeric solution, a fibrous membrane/cathode composite in which an ultra-fine fibrous porous polymer membrane was combined with one side of LiCoO₂ cathode and a fibrous membrane/anode composite in which an ultra-fine fibrous porous polymer membrane was combined with one side of graphite anode were respectively prepared in the same manner as in Example 1-1.

Using the same polymeric solution, a fibrous membrane/cathode composite in which an ultra-fine fibrous porous polymer membrane was combined with both sides of LiCoO₂ cathode and a fibrous membrane/anode composite in which an ultra-fine fibrous porous polymer membrane was combined with both sides of graphite anode were respectively prepared in the same manner as in Example 1-1.

### Example 1-3

10 g of PVdF (Kynar 761), 5 g of PAN (obtained from Polyscience Company, molecular weight of 150,000) and 5 g of PMMA (obtained from Polyscience Company, molecular weight of 100,000) were dissolved in 100 g of dimethylacetamide, and the resulting solution was used for preparing a fibrous membrane/cathode composite in which an ultra-fine fibrous porous polymer membrane was combined with one side of LiCoO₂ cathode and a fibrous membrane/anode composite in which a fibrous membrane fibrous porous polymer membrane was combined with one side of graphite anode in the same manner as in Example 1-1.

Using the same polymeric solution, a fibrous membrane/cathode composite in which an ultra-fine fibrous porous polymer membrane was combined with both sides of LiCoO₂ cathode and a fibrous membrane/anode composite in which an ultra-fine fibrous porous polymer membrane was combined with both sides of graphite anode were respectively prepared in the same manner as in Example 1-1.

### Example 2

### Preparation of a Polymer Electrolyte

### Example 2-1

0.5 g of PAN (obtained from Polyscience Company, molecular weight of 150,000), 2 g of PVdF (Kynar 761) and 0.5 g of PMMA (obtained from Polyscience Company) were added into 80 g of 1M LiPF₆ solution in EC/DMC/DEC(1/1/1), and the resultant was mixed for 12 hours and then heated at 130° C. for one hour, to give a clear polymeric solution.

### Example 2-2

0.5 g of PAN (obtained from Polyscience Company, molecular weight of 150,000), 2 g of PVdF (Kynar 761) and 0.5 g of PMMA (obtained from Polyscience Company) were added into a mixture of 15 g of 1M LiPF₆ solution in EC/DMC/DEC(1/1/1) and 1 g of dimethylacetamide (DMA) as a pasticizer, and the resultant was mixed for 12 hours and then heated at 130° C. for one hour to give a clear polymer electrolyte. When a viscosity of 3,000 cps suitable for casting was obtained, it was cast onto the fibrous membrane of a fibrous membrane/electrode composite prepared in Example 1-1, which was combined with the surface of one side of an electrode, by die casting method, to form a hybrid type polymer electrolyte in which pores of the fibrous membrane were impregnated with the polymer electrolyte.

### Example 2-3

4 g of polyethyleneglycol dimethylether (PEGDME, fabricated by Aldrich Company, molecular weight of 2,000) was added into 20 g of 1M LiPF₆ solution in EC/DMC/DEC(1/1/1), to give a clear polymer electrolyte.

### Example 2-4

4 g of oligomer of polyethyleneglycol diacrylate (PEGDA, prepared by Aldrich Company, molecular weight of 742) was added into 20 g of 1M LiPF₆ solution in EC/DMC/DEC(1/1/1), and the resulting mixture was made to be uniform by sufficiently mixing at room temperature for 3 hours. The resultant was respectively cast onto a fibrous membrane of a fibrous membrane/cathode composite and a fibrous membrane/anode composite, which were obtained in Example 1-1. An ultraviolet lamp having the power of 100 W was irradiated to the porous polymer matrix for about 1.5 hours so as to induce polymerization of the oligomers, to obtain a hybrid type polymer electrolyte in which the pores of the fibrous membrane were impregnated with the polymer electrolyte.

### Example 3

### Fabrication of a Lithium Secondary Battery

### Example 3-1

The cathode and anode, in which an ultra-fine fibrous porous polymer membrane was respectively combined onto one surfaces of the electrodes obtained in Example 1-1, were adhered to each other, and the resultant was heat-laminated at 110° C. so as to make into one body, thereby to obtain an electrode body in which cathode/fibrous membrane/anode were combined together. The electrode body was cut so as to be 3 cm×4 cm in size and then stacked. Terminals were welded onto the electrodes and the resultant was then inserted into a vacuum casing. 1M LiPF₆ solution in EC/DMC/DEC (1/1/1) was injected into the casing, and the casing was then vacuum-sealed to give a lithium secondary battery.

### Example 3-2

The cathode and anode, in which an ultra-fine fibrous porous polymer membrane was respectively combined onto one surfaces of the electrodes obtained in Example 1-2, were adhered to each other, and the resultant was heat-laminated at 110° C. so as to make into one body, thereby to obtain an electrode body in which cathode/fibrous membrane/anode were combined together. The electrode body was cut so as to be 3 cm×4 cm in size and stacked. Terminals were welded onto the electrodes and then the resultant was inserted into a vacuum casing. 1M LiPF₆ solution in EC/DMC/DEC (1/1/1) was injected into the casing, and the casing was then finally vacuum-sealed to give a lithium secondary battery.

### Example 3-3

The cathode and anode, in which an ultra-fine fibrous porous polymer membrane was respectively combined onto one surfaces of the electrodes obtained in Example 1-3, were adhered to each other, and the resultant was heat-laminated at 110° C. so as to make into one body, thereby to obtain an electrode body in which cathode/fibrous membrane/anode were combined together. The electrode body was cut so as to be 3 cm×4 cm in size and stacked. Terminals were welded onto the electrodes and then the resultant was inserted into a vacuum casing. 1M LiPF₆ solution in EC/DMC/DEC (1/1/1) was injected into the casing, and the casing was then vacuum-sealed to give a lithium secondary battery.

### Example 3-4

The cathode and anode, in which an ultra-fine fibrous porous polymer membrane was respectively combined onto one surfaces of the electrodes obtained in Example 1-1, were adhered to each other, and the resultant was heat-laminated at 110° C. so as to make into one body, thereby to obtain an electrode body in which cathode/fibrous membrane/anode were combined together. The electrode body was cut so as to be 3 cm×4 cm in size and stacked. Terminals were welded onto the electrodes and then the resultant was inserted into a vacuum casing. A polymer electrolyte prepared in Example 2-1 was injected into the casing, and the casing was then vacuum-sealed to give a lithium secondary battery.

### Example 3-5

The fibrous membrane/cathode composite and fibrous membrane/anode composite prepared in Example 2-2, in which the pores of the fibrous membrane were respectively impregnated with the polymer electrolyte, were adhered to each other, and the resultant was heat-laminated at 110° C. so as to make into one body, to obtain an electrode body in which cathode/fibrous membrane/anode were combined together. The electrode body was cut so as to be 3 cm×4 cm in size and stacked. Terminals were welded onto the electrodes, and then the resultant was inserted into a vacuum casing. 1M LiPF₆ solution in EC/DMC/DEC (1/1/1) was injected into the casing, and the casing was then vacuum-sealed to give a lithium secondary battery.

### Example 3-6

The cathode and anode, in which an ultra-fine fibrous porous polymer membrane was respectively coated onto one surfaces of the electrodes obtained in Example 1-1 were adhered to each other, and the resultant was heat-laminated at 110° C., to obtain an electrode body in which cathode/fibrous membrane/anode were combined into one body. The electrode body was cut so as to be 3 cm×4 cm in size and stacked. Terminals were welded onto the electrodes and then the resultant was inserted into a vacuum casing. A polymer electrolyte obtained in Example 2-3 was injected into the casing, and the casing was then vacuum-sealed to give a lithium secondary battery.

### Example 3-7

The fibrous membrane/cathode composite and fibrous membrane/anode composite prepared in Example 2-4, in which the pores of the fibrous membrane were respectively impregnated with the polymer electrolyte, were adhered to each other, and the resultant was heat-laminated at 110° C. so as to make into one body, to obtain an electrode body in which cathode/fibrous membrane/anode were combined together. The electrode body was cut so as to be 3 cm×4 cm in size and stacked. Terminals were welded onto the electrodes and then the resultant was inserted into a vacuum casing. 1M LiPF₆ solution in EC/DMC/DEC (1/1/1) was injected into the casing, and the casing was then vacuum-sealed to give a lithium secondary battery.

### Comparative Example 1

A lithium secondary battery was fabricated by stacking electrodes and separator in order of anode, PE separator, cathode, PE separator and anode, inserting the resultant into a vacuum casing, injecting 1M LiPF₆ solution in EC/DMC/DEC(1/1/1) into the casing, and then finally vacuum-sealing the casing.

### Comparative Example 2

According to the conventional preparation method of a gel-polymer electrolyte, 9 g of 1M LiPF₆ solution in EC/PC was added to 3 g of PAN. The resultant was mixed for 12 hours and then heated at 130° C. for one hour to give a clear polymeric solution. When a viscosity of 10,000 cps suitable for casting was obtained, the polymeric solution was cast by die-casting to give a polymer electrolyte film. A lithium secondary battery was fabricated by stacking, in order, graphite anode, an electrolyte, a LiCoO₂ cathode, an electrolyte and graphite anode, welding terminals onto the electrodes, inserting the resulting stacked plate into a vacuum casing, injecting 1M LiPF₆solution in EC/DMC/DEC(1/1/1) into the casing, and then finally vacuum-sealing the casing.

### Comparative Example 3

20 g of PVdF (Kynar 761) was added into 100 g of dimethylacetamide/ acetone mixture, and the resulting mixture was stirred at room temperature to give a clear polymeric solution. This polymeric solution was injected into the barrel 1 of the electrospinning apparatus as depicted in FIG. 3 and discharged with the constant quantity pump 2 at 100 μl/min. Herein, 9 kV electric charge was applied to the spinning nozzle 4 by the high voltage generator 3, to form an ultra-fine fibrous porous polymer membrane having a thickness of 50 μm onto the earthed metal collector plate 5 in the form of a conveyor moving at 1 m/min. The ultra-fine fibrous porous polymer membrane was separated from the collector plate and then inserted between a cathode plate and an anode plate, and the resultant was heat-laminated so as to make into one body at 110° C. The plate was cut so as to be 3 cm×4 cm in size and stacked. Terminals were welded onto the electrodes and then the resultant was inserted into a vacuum casing. 1M LiPF₆ solution in EC/DMC/DEC (1/1/1) was injected into the casing, and the casing was then finally vacuum-sealed to give a lithium secondary battery.

### Example 4

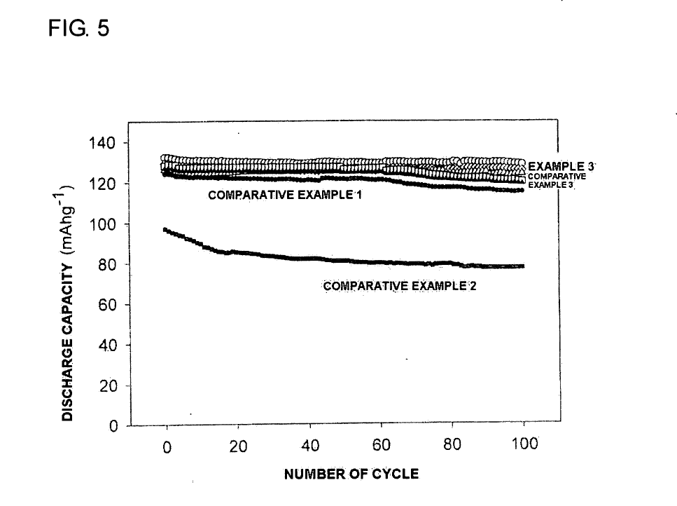

Charge/discharge characteristics of the lithium secondary batteries fabricated in Examples 3-1 to 3-7 and Comparative Examples 1 to 3 were tested, and FIG. 5 shows the results. The tests for obtaining the charge/discharge characteristics were performed by a charge/discharge method of, after charging the batteries with a C/2 constant current and 4.2V constant voltage, discharging with a C/2 constant current, and the electrode capacities and cycle life based on the cathode were tested.

FIG. 5 shows that the cycle performances of the lithium secondary batteries of Examples 3-1 to 3-7 were better than those of the lithium secondary batteries of Comparative Examples 1 to 3. It is believed that such improvement in the battery characteristics came from the interfacial resistance reduction and ionic conductivity improvement, due to the close adhesion of the electrodes and the separator.

### Example 5

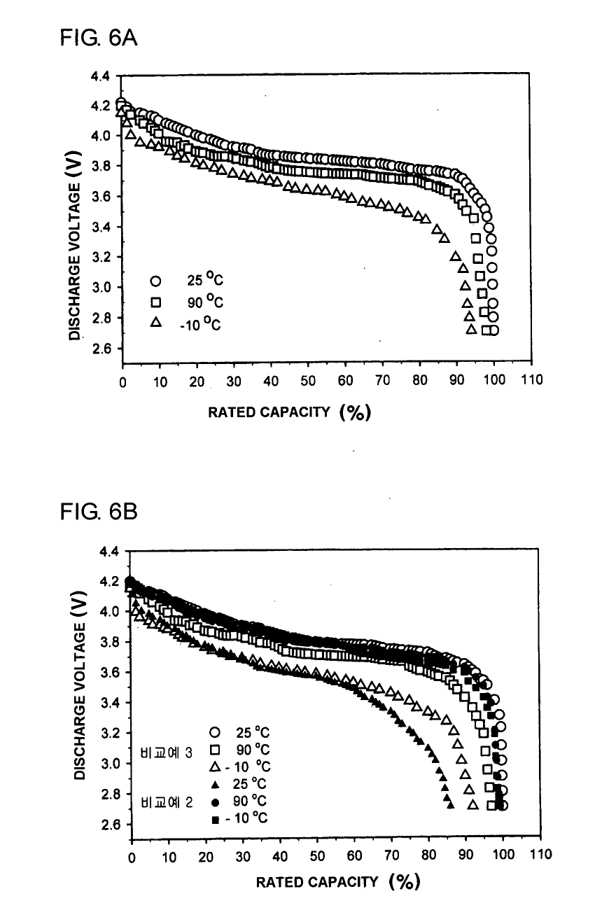

Low- and high-temperature characteristics of the lithium secondary batteries of Example 3-1, and Comparative Examples 2 and 3 were tested and FIGS. 6a and 6b show the results, wherein FIG. 6a is of Example 3-1 and FIG. 6b is of Comparative Examples 2 and 3. The tests for determining the low- and high-temperature characteristics of the lithium secondary batteries were performed by a charge/discharge method of charging the lithium batteries with a C/2 constant current and 4.2 V constant voltage, and then discharging with a C/5 constant current.

FIGS. 6a and 6b show that the low- and high-temperature characteristics of the lithium secondary battery of Example 3-1 are better than those of the batteries of Comparative Examples 2 and 3. In particular, it shows that the battery of Example 3-1 has an outstanding characteristic of 94% even at −10° C.

### Example 6

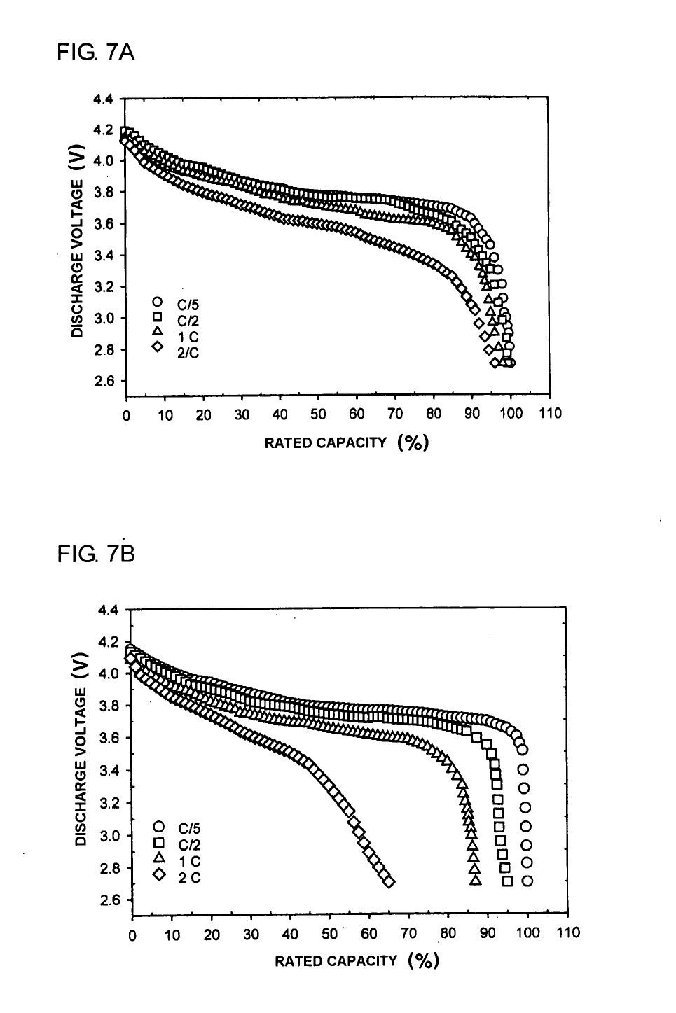

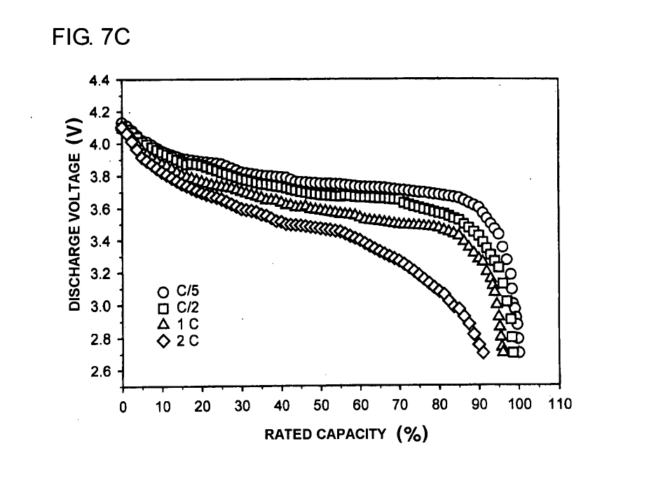

High rate discharge characteristics of the lithium secondary batteries of Example 3-1 and Comparative Examples 2 and 3 were tested and FIGS. 7a and 7b illustrate the results, wherein FIG. 7a is of Example 3-1, FIG. 7a is of Comparative Example 2, and FIG. 7c is of Comparative Example 3. The tests for determining the high rate discharge characteristics of the lithium secondary batteries were performed by a charge/discharge method of charging the lithium batteries with a C/2 constant current and 4.2 V constant voltage, and then discharging while varying the constant current to C/5, C/2,1C and 2C.

As depicted in FIG. 7a, the lithium secondary battery of Example 3-1 exhibited capacities of 99% at C/2 discharge, 98% at 1C discharge and 96% at 2C discharge based on the value of C/5 discharge. However, the lithium secondary battery of Comparative Example 2 exhibited low capacities of 87% at 1C discharge and 65% at 2C discharge based on the value of C/5 discharge (See FIG. 7b). The lithium secondary battery of Comparative Example 3 exhibited low capacities of 96% at 1C discharge and 92% at 2C discharge based on the value of C/5 discharge (See FIG. 7c). Accordingly, it was discovered that the high rate discharge characteristics of the lithium secondary battery of Example 3-1 was better than that of the lithium secondary batteries of Comparative Examples 2 and 3.

As described-above, the present invention provides a new lithium secondary battery and a fabrication method thereof having advantages of both lithium ion battery and lithium polymer battery.

In a lithium secondary battery according to the present invention, an ultra-fine fibrous porous polymer membrane is combined with an electrode, and the pores of the fibrous membrane were impregnated with an organic electrolyte solution or a polymer electrolyte, and therefore, adhesion of the fibrous membrane and the electrolyte is improved remarkably to result in reducing interfacial resistance. Electrolyte maintaining ability of the fibrous membrane is also superior, and therefore, electrolyte is not leaked, and its compatibility with an organic electrolyte solution is good. Accordingly, the lithium secondary battery according to the present invention is superior in an energy density, cycle characteristics, low- and high-temperature characteristics, high rate discharge characteristics and stability.

The fabrication process of a lithium secondary battery according to the present invention is simple compared with those of the conventional methods, and therefore, it can be advantageously applied for scaling-up of a lithium secondary battery.

1. A lithium secondary battery comprising:
(a) an electrospun fibrous membrane/electrode composite in which an ultra-fine fibrous porous polymer membrane is combined with an electrode into one body; and
(b) a hybrid type polymer electrolyte in which pores of the electrospun ultra-fine fibrous porous polymer membrane are impregnated with an organic electrolyte solution or a polymer electrolyte.

2. The lithium secondary battery according to claim 1, wherein fibers in the ultra-fine fibrous porous polymer membrane have a diameter of 1-3000 nm.

3. The lithium secondary battery according to claim 1, wherein the ultra-fine fibrous porous polymer membrane has a thickness of 1-100 μm.

4. The lithium secondary battery according to claim 1, wherein a polymer for the ultra-fine fibrous porous polymer membrane is selected from the group consisting of polyethylene, polypropylene, cellulose, cellulose acetate, cellulose acetate butylate, cellulose acetate propionate, poly(vinylpyrrolidone-vinylacetate), poly{bis[2-(2-methoxyethoxy)phosphagene]}, poly(ethyleneimide), polyethylene-glycol dialkylether, polyethyleneglycol dialkylester, polyethyleneoxide, polyethylenesuccinate, polyethylenesulfide, poly(oxymethylene-oligo-oxyethylene), polypropyleneoxide, polyvinylacetate, polyurethane, polyetherurethane, polystyrene, polystyrene acrylonitrile copolymer, polyester, nylon, polyacrylonitrile, polyacrylonitrile methylmethacrylate copolymer, polymethylmethacrylate, polymethylmethacrylate copolymer, polyvinylchloride, poly(vinylidene fluoride), poly(vinylidenefluoride-co-hexafluoropropylene), perfluoropolymer and mixtures thereof.

5. The lithium secondary battery according to claim 1, wherein the organic electrolyte solution is an electrolyte in which a lithium salt is dissolved in an organic solvent, and the polymer electrolyte is a polymer/lithium salt complex or an electrolyte comprising a polymer and an organic electrolyte solution.

6. The lithium secondary battery according to claim 5, wherein the polymer electrolyte further comprises an inorganic additive selected from the group consisting of TiO₂, BaTiO₃, Li₂O, LiF, LiOH, Li₃N, BaO, Na₂O, Li₂CO₃, LiAlO₂, SiO₂Al₂O₃, PTFE and mixtures thereof.

7. The lithium secondary battery according to claim 5, wherein the lithium salt is selected from the group consisting of LiPF₆, LiClO₄, LiAsF₆, LiBF₄ and LiCF₃SO₃.

8. The lithium secondary battery according to claim 1, wherein a polymer for the polymer electrolyte is selected from the group consisting of cellulose, cellulose acetate, cellulose acetate butylate, cellulose acetate propionate, poly(vinylpyrrolidone-vinylacetate), poly{bis[2-(2-methoxyethoxy)phosphagene]}, poly(ethyleneimide), polyethyleneglycol dialkylether, polyethyleneglycol dialkylester, oligomers of polyethyleneglycol diacrylate and derivatives thereof, polyethyleneoxide, polyethylenesuccinate, polyethylenesulfide, poly(oxymethylene-oligo-oxyethylene), polypropyleneoxide, polyether, polyvinylacetate, polyurethane, polyetherurethane, polystyrene, poly(styrene-acrylonitrile), polyacrylonitrile, poly(acrylonitrile-methylmethacrylate), polymethylmethacrylate and copolymers thereof, polyvinylchloride, poly(vinylidene fluoride), poly(vinylidenefluoride-co-hexafluoropropylene), perfluoro-polymers and mixtures thereof.

9. The lithium secondary battery according to claim 5, wherein the weight ratio of the polymer to the organic electrolyte solution in the electrolyte comprising a polymer and an organic electrolyte solution is in the range of 1:1-50.

10. The lithium secondary battery according to claim 5, wherein the organic solvent is selected from the group consisting of ethylene carbonate, propylene carbonate, diethyl carbonate, dimethyl carbonate, ethylmethyl carbonate and mixtures thereof.

11. The lithium secondary battery according to claim 1, wherein the fibrous membrane/electrode composite include a fibrous membrane/anode composite and a fibrous membrane/cathode composite.

12. The lithium secondary battery according to claim 11, wherein the anode comprises an anode active material selected from the group consisting of graphite, cokes, hard carbon, tin oxide, lithiated compounds thereof, lithium, lithium alloys and mixtures thereof.

13. The lithium secondary battery according to claim 11, wherein the cathode includes a cathode active material selected from the group consisting of LiClO₂, LiNiO₂, LiNiCoO₂, LiMn₂O₄, V₂O₅, V₆O₁₃ and mixtures thereof.

14. A method for fabricating a lithium secondary battery, comprising the steps of:
(a) electrospinning a polymer melt or a polymeric solution onto an earthed metal conveyor collector plate of an electrospinning apparatus while applying a voltage, to prepare an ultra-fine fibrous porous polymer membrane on the earthed metal conveyor collector plate;
(b) adhering an active surface of an electrode onto the ultra-fine fibrous porous polymer membrane prepared in step (a), hot pressing the resultant, and followed by separating the same from the collector plate, to obtain a fibrous membtane/electrode composite in which the ultra-fine fibrous porous polymer membrane is combined with the electrode into one body; and
(c) fabricating a lithium secondary battery with the fibrous membrane/electrode composite.

15. The method according to claim 14, wherein fibers in the ultra-fine fibrous porous polymer membrane have a diameter of 1-3000 nm.

16. The method according to claim 14, wherein the ultra-fine fibrous porous polymer membrane has a thickness of 1-100 μm.

17. The method according to claim 14, wherein the fibrous membrane/electrode composite includes a fibrous membrane/anode composite and a fibrous membrane/cathode composite.

18. The method according to claim 17, wherein the anode comprises an anode active material selected from the group consisting of graphite, cokes, hard carbon, tin oxide, lithiated compounds thereof, lithium, lithium alloys and mixtures thereof.

19. The method according to claim 17, wherein the cathode comprises a cathode active material selected from the group consisting of LiClO₂, LiNiO₂, LiNiCoO₂, LiMn₂O₄, V₂O₅, V₆O₁₃ and mixtures thereof.

20. The method according to claim 17, wherein the step (c) comprising the following sub-steps of:
(i) heat-laminating the fibrous membrane/cathode composite with the fibrous membrane/anode composite, to obtain an electrode body in which the cathode/fibrous membrane /anode are combined into one body; and
(ii) injecting an organic electrolyte solution or a polymer electrolyte into the electrode body.

21. The method according to claim 17, wherein the step (c) further comprises the following sub-steps of:
(i) respectively injecting an organic electrolyte solution or a polymer electrolyte into the fibrous membrane/cathode composite and the fibrous membrane/anode composite;
(ii) adhering the fibrous membrane/cathode composite and the fibrous membrane/anode composite anode to each other; and
(iii) laminating the resultant.

22. The method according to claim 14, wherein the polymer of the step (a) is selected from the group consisting of polyethylene, polypropylene, cellulose, cellulose acetate, cellulose acetate butylate, cellulose acetate propionate, poly(vinylpyrrolidone-vinylacetate), poly{bis[2-(2-methoxyethoxy)phosphagene]}, poly(ethyleneimide), polyethyleneglycol dialkylether, polyethyleneglycol dialkylester, polyethyleneoxide, polyethylenesuccinate, polyethylenesulfide, poly(oxymethylene-oligo-oxyethylene), polypropyleneoxide, polyvinylacetate, polyurethane, polyetherurethane, polystyrene, polystyrene acrylonitrile copolymer, polyester, nylon, polyacrylonitrile, polyacrylonitrile methylmethacrylate copolymer, polymethylmethacrylate, polymethylmethacrylate copolymer, polyvinylchloride, poly(vinylidene fluoride), poly(vinylidenefluoride-co-hexafluoropropylene), perfluoro-polymer and mixtures thereof.

23. The method according to claim 20, wherein the organic electrolyte solution is an electrolyte in which a lithium salt is dissolved in an organic solvent, and the polymer electrolyte is a polymer/lithium salt complex or an electrolyte comprising a polymer and an organic electrolyte solution.

24. The method according to claim 23, wherein the lithium salt is selected from the group consisting of LiPF₆, LiClO₄, LiAsF₆, LiBF₄ and LiCF₃SO₃.

25. The method according to claim 23, wherein the polymer electrolyte further comprises an inorganic additive selected from the group consisting of TiO₂, BaTiO₃, Li₂O, LiF, LiOH, Li₃N, BaO, Na₂O, Li₂CO₃, LiAlO₂, SiO₂, Al₂O₃, PTFE and mixtures thereof.

26. The method according to claim 23, wherein the polymer for the polymer electrolyte is selected from the group consisting of cellulose, cellulose acetate, cellulose acetate butylate, cellulose acetate propionate, poly(vinylpyrrolidone-vinylacetate), poly{bis[2-(2-methoxyethoxy)phosphagene]}, poly(ethyleneimide), polyethyleneglycol dialkylether, polyethyleneglycol dialkylester, triethyleneglycol dialkylether, oligomers of polyethyleneglycol diacrylate and derivatives thereof, polyethyleneoxide, polyethylenesuccinate, polyethylenesulfide, poly(oxymethylene-oligo-oxyethylene), polypropyleneoxide, polyether, polyvinylacetate, polyurethane, polyetherurethane, polystyrene, poly(styrene acrylonitrile), polyacrylonitrile, poly(acrylonitrile-methylmethacrylate), polymethylmethacrylate and copolymers thereof, polyvinylchloride, poly(vinylidene fluoride), poly(vinylidenefluoride-co-hexafluoropropylene), perfluoro-polymers and mixtures thereof.

27. The method according to claim 23, wherein the weight ratio of the polymer to the organic electrolyte solution in the electrolyte comprising a polymer and an organic electrolyte solution is in the range of 1:1-50.

28. The method according to claim 23, wherein the organic solvent is selected from the group consisting of ethylene carbonate, propylene carbonate, diethyl carbonate, dimethyl carbonate, ethylmethyl carbonate and mixtures thereof.
